(19) United States
(12) Patent Application Publication
(10) Pub. No.: US 2010/0019676 A1
(43) Pub. Date: Jan. 28, 2010

(54) Electric generator for bicycle

(76) Inventor: Jen-Yen Yen, Changhua Hsien (TW)

Correspondence Address: CHARLES E. BAXLEY, ESQUIRE, 90 JOHN STREET, SUITE 309, NEW YORK, NY, 10038, US

(21) Appl. No.: 12/217,081

(22) Filed: Jul. 28, 2008

(51) Int. Cl. B60Q 1/26; B62J 6/12

(52) U.S. Cl. 315/78; 310/67 A

(57) ABSTRACT

An electric generator for a bicycle includes a housing for attaching to a bicycle frame, a rotary member rotatably received in the housing for engaging with an axle of the bicycle, a reduction gearing received in the housing and engaged with the rotary member, a motor received in the housing and having a pinion attached to a spindle and engaged with the reduction gearing for being driven by the reduction gearing and the rotary member and for generating an electric energy, a battery electrically coupled to the motor for receiving and storing the electric energy generated by the motor and for supplying the electric energy to energize a light device, or other electric facilities.

### BACKGROUND OF THE INVENTION

1. Field of the Invention

The present invention relates to an electric generator, and more particularly to an electric generator for easily and readily attaching to various bicycles and for generating an electricity or electric energy to energize the light devices, mobile phones, or other electric facilities.

2. Description of the Prior Art

Typical electric generators have been developed and attached onto the bicycles for generating an electricity or electric energy to energize the light devices for the bicycles, and comprise a rotary member frictionally engaged with the wheel rim or the tire and rotated or driven by the wheel rim or the tire to generate the electricity or electric energy.

For example, U.S. Pat. No. 3,894,281 to Bloomfield discloses one of the typical battery and generator vehicle lighting systems also comprising a generator attached to the rear fork of the bicycle, and a rotary member frictionally engaged with the wheel rim or the tire and rotated or driven by the wheel rim or the tire to generate the electricity or electric energy.

However, the electricity or electric energy generated by the generator may be used to energize the light devices only, but may not be used to energize the mobile phones or the other electric facilities.

U.S. Pat. No. 4,677,328 to Kumakura discloses another typical generator for use on bicycle and comprising an annular magnet assembly as a rotor, and a coil assembly disposed around the front wheel axle of the bicycle for acting with the rotating annular magnet assembly and for generating the electricity or electric energy.

However, similarly, the electricity or electric energy generated by the typical generator is used to energize the light devices only, but may not be used to energize the mobile phones or the other electric facilities. In addition, the wheel hub of the bicycle should be modified to accommodate the typical generator, such that the typical generator may not be easily and readily attached to various bicycles.

U.S. Pat. No. 5,378,553 to Shoji discloses a further typical battery case attaching unit for attaching to a bicycle and for lighting purposes, and one or more batteries are required to be provided and disposed in the battery case and electrically coupled to the light devices for energizing the light devices.

However, one or more batteries are required to be used and may pollute our environment.

U.S. Pat. No. 5,690,410 to Lin discloses a further typical light device for the bicycles, and comprising a sensor attached to the front fork of the bicycle, and an inducing block attached to the spokes of the front wheel and having an equal radial distance as that of the sensor relative to the wheel hub such that the inducing block may pass the sensor when the wheel is rotated.

However, the sensor and the inducing block may not be used to effectively generate the electricity or electric energy.

U.S. Pat. No. 6,501,199 to Hung discloses a still further typical automatic wheel-driven generating means and light devices for the bicycles, and comprising a winding reel enclosed between left and right magnetic poles and fixedly mounted on a hollow column, and a magnet holder mounted on the axle and carrying magnets for generating the electricity or electric energy.

However, similarly, the wheel hub of the bicycle should be modified to accommodate the typical automatic wheel-driven generating means, such that the typical automatic wheel-driven generating means may not be easily and readily attached to various bicycles.

The present invention has arisen to mitigate and/or obviate the afore-described disadvantages of the conventional electric generators for the bicycles.

### SUMMARY OF THE INVENTION

The primary objective of the present invention is to provide an electric generator provided for easily and readily attaching to various bicycles and for generating an electricity or electric energy to energize the light devices, mobile phones, or other electric facilities without batteries.

In accordance with one aspect of the invention, there is provided an electric generator for a bicycle comprising a housing for attaching to a bicycle frame, and including a chamber formed therein, a rotary member rotatably received in the chamber of the housing for frictionally engaging with an axle of the bicycle and for being rotated by the axle, a reduction gearing received in the chamber of the housing and engaged with the rotary member, a motor received in the chamber of the housing and including a pinion attached to a spindle of the motor and engaged with the reduction gearing for being driven by the reduction gearing and the rotary member and for generating an electric energy, a battery electrically coupled to the motor for receiving and storing the electric energy generated by the motor, and a light device electrically coupled to the battery for being energized by the battery.

An electric coupler may further be provided and electrically coupled to the battery for electrically coupling to the light device. A circuit board may further be provided and received in the chamber of the housing and attached to the housing.

An indicating light device may further be provided and electrically coupled to the battery for being energized by the battery to generate an indicating light. A switch may further be provided and electrically coupled to the battery for controlling the electric energy to the light device.

The housing includes a cover secured to the housing for closing the chamber of the housing and for retaining the rotary member and the reduction gearing and the motor in the housing.

The rotary member includes a primary gear attached thereto and rotated in concert with the rotary member, the reduction gearing includes a driven gear rotatably attached to the housing and meshed with the primary gear, an intermediate gear rotatably attached to the housing and having a pinion engaged with the driven gear, and a follower gear rotatably attached to the housing and having a pinion engaged with the intermediate gear, and the follower gear is engaged with the pinion of the motor. The housing includes a plate secured to the housing for rotatably supporting the intermediate gear and the follower gear.

The housing includes an opening formed therein and communicating with the chamber of the housing for receiving the axle. The housing includes a bracket secured to the housing and having an opening formed in the bracket for accommodating the axle.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a plan schematic view of a bicycle having an electric generator in accordance with the present invention;

FIG. 2 is an enlarged partial plan schematic view of the bicycle and the electric generator;

FIG. 3 is an enlarged plan schematic view of the electric generator;

FIG. 4 is an exploded view of the electric generator for the bicycle; and

FIG. 5 is a block diagram illustrating the operation of the electric generator.

### DETAILED DESCRIPTION OF THE PREFERRED EMBODIMENT

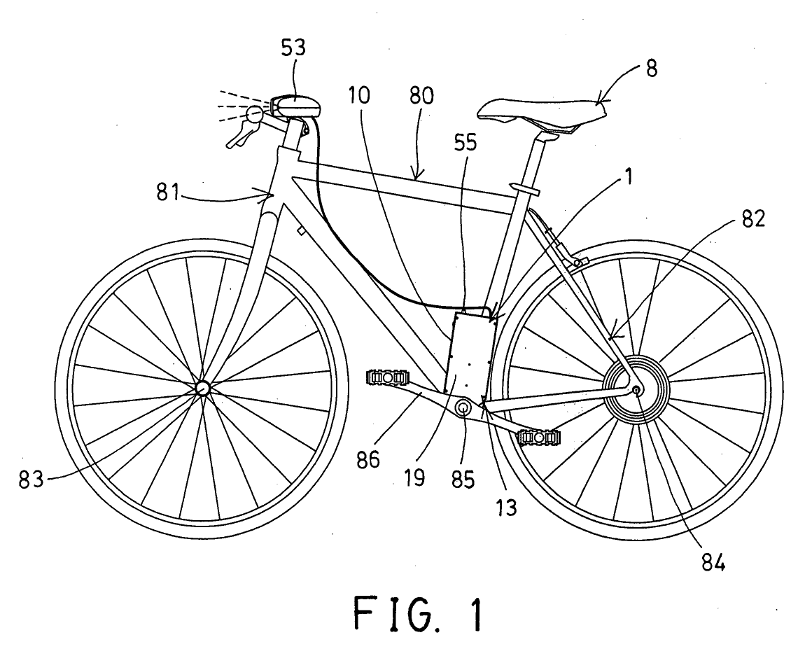

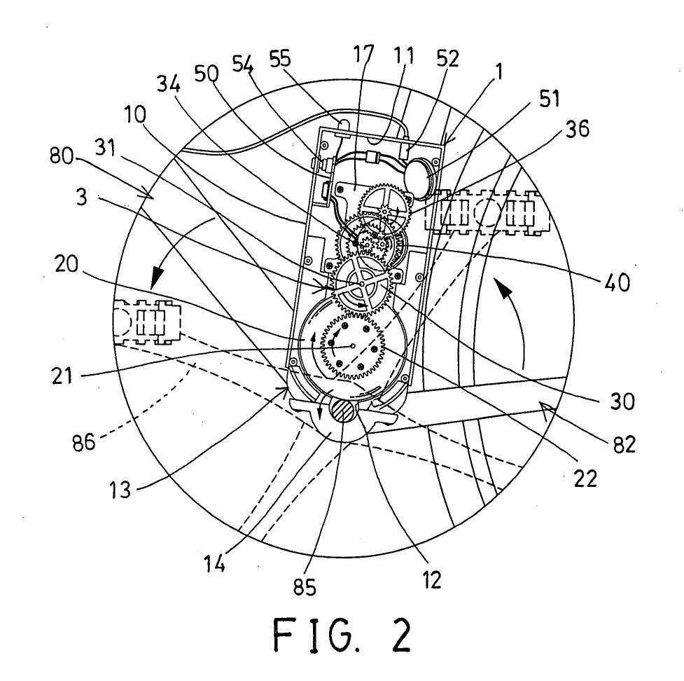

Referring to the drawings, and initially to FIGS. 1 and 2, an electric generator 1 in accordance with the present invention is provided for easily and readily attaching to a bicycle 8, such as attached to the bicycle frame 80, or the front fork 81 or the rear fork 82 of the bicycle frame 80 of the bicycle 8 selectively, and for engaging with the front wheel axle 83, the rear wheel axle 84, or the crank axle 85 of the cranks 86 and for allowing the electric generator 1 to be selectively rotated or driven by the front wheel axle 83, the rear wheel axle 84, or the crank axle 85 to generate the electricity or electric energy automatically.

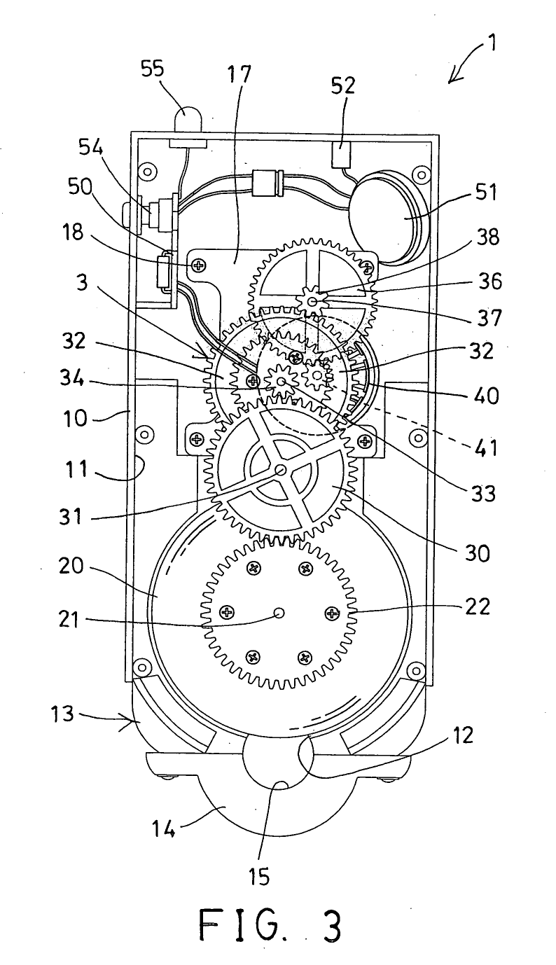

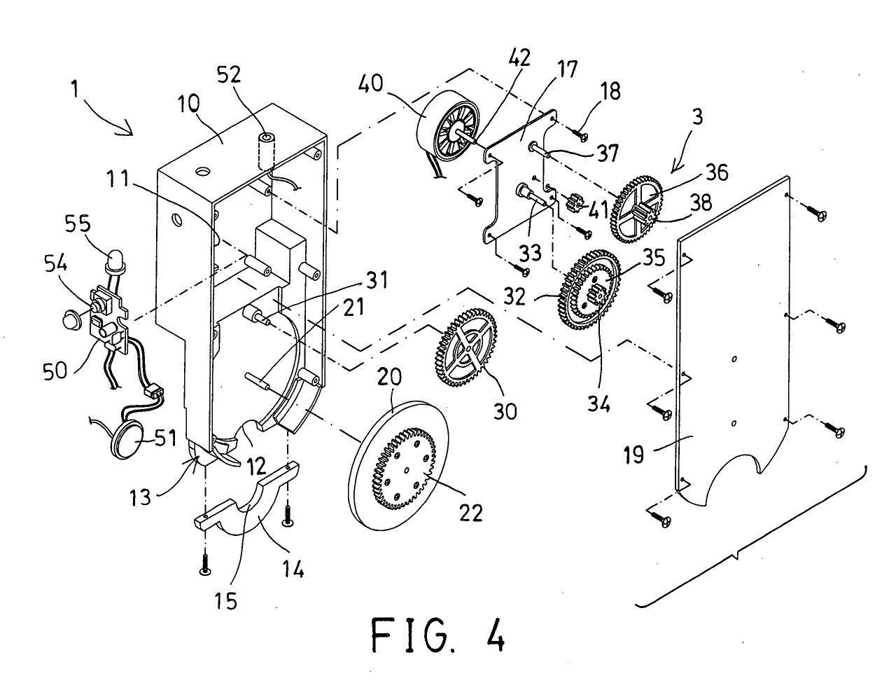

As shown in FIGS. 1-4, the electric generator 1 comprises an outer housing 10 attached or secured to the bicycle frame 80 with latches or fasteners (not shown), and including a chamber 11 formed therein, and including a notch or opening 12 formed in the lower portion 13 thereof and communicating with the chamber 11 thereof for receiving the front wheel axle 83, the rear wheel axle 84, or the crank axle 85 (FIG. 2) and for allowing the axle 85 to be laterally extended into the chamber 11 of the housing 10, and comprises a cap or bracket 14 attached or secured to the lower portion 13 of the housing 10, and including a notch or opening 15 formed therein and aligned with and communicating with the opening 12 of the housing 10 for stably accommodating and retaining the axle 85 to the housing 10.

A rotary member 20 is rotatably received in the chamber 11 of the housing 10 with a pivot shaft 21, and includes a primary gear 22 attached or secured thereon or formed integral with the rotary member 20 and rotated in concert with the rotary member 20, the rotary member 20 is made of soft or resilient materials, such as plastic or rubber materials, or other synthetic materials for frictionally engaging with the axle 85 and for allowing the rotary member 20 and the primary gear 22 to be rotated or driven by the axle 85. The housing 10 includes a plate 17 received in the chamber 11 of the housing 10 and secured to the housing 10 with one or more fasteners 18.

A reduction gearing 3 is also rotatably received in the chamber 11 of the housing 10 and includes a driven gear 30 rotatably attached to the housing 10 with a pivot pin 31 and meshed or engaged with the primary gear 22 for being rotated or driven by the primary gear 22 and the rotary member 20. The reduction gearing 3 further includes an intermediate gear 32 rotatably attached to the plate 17 or the housing 10 with another pivot pin 33, and the intermediate gear 32 includes a pinion 34 attached or secured thereon or formed integral with the intermediate gear 32 and meshed or engaged with the driven gear 30 for being rotated or driven by the driven gear 30, and may include a wheel or gear 35 formed integral with the intermediate gear 32.

A follower gear 36 is further provided and rotatably attached to the plate 17 or the housing 10 with a further pivot pin 37, and includes another pinion 38 attached or secured thereon or formed integral with the follower gear 36 and meshed or engaged with the intermediate gear 32 for being rotated or driven by the intermediate gear 32. A motor 40 is received in the chamber 11 of the housing 10 and attached or secured to the plate 17 or the housing 10 with latches or fasteners (not shown), and includes a further pinion 41 attached or secured to the spindle 42 and meshed or engaged with the follower gear 36 for allowing the spindle 42 of the motor 40 to be rotated or driven by the follower gear 36 of the reduction gearing 3 and for generating an electricity or electric energy.

A circuit board 50 is received in the chamber 11 of the housing 10 and attached or secured to the housing 10, a chargeable battery 51 is also received in the chamber 11 of the housing 10 and electrically coupled to the motor 40 for receiving and storing the electricity or electric energy generated by the motor 40, an electric socket or coupler 52 is attached or secured to the housing 10 and electrically coupled to the battery 51 for electrically coupling to the light device 53 (FIG. 1), the mobile phones, the personal music players (MP3), the multimedia devices, or other electric facilities (not shown) and for energizing the light device 53 or the other electric facilities.

A switch 54 is attached or secured to the plate 17 or the housing 10 and electrically coupled to the battery 51 and/or the coupler 52 for switching or controlling the electricity or electric energy to the light device 53 (FIG. 1), the mobile phones, the personal music players, the multimedia devices, or other electric facilities. An indicating light device 55 may further be provided and electrically coupled to the battery 51 for being energized by the battery 51 to generate the indicating light or the like. A cover 19 may further be provided and attached or secured to the housing 10 for closing the chamber 11 of the housing 10 and for stably retaining the rotary member 20 and the reduction gearing 3 and the other elements in the housing 10.

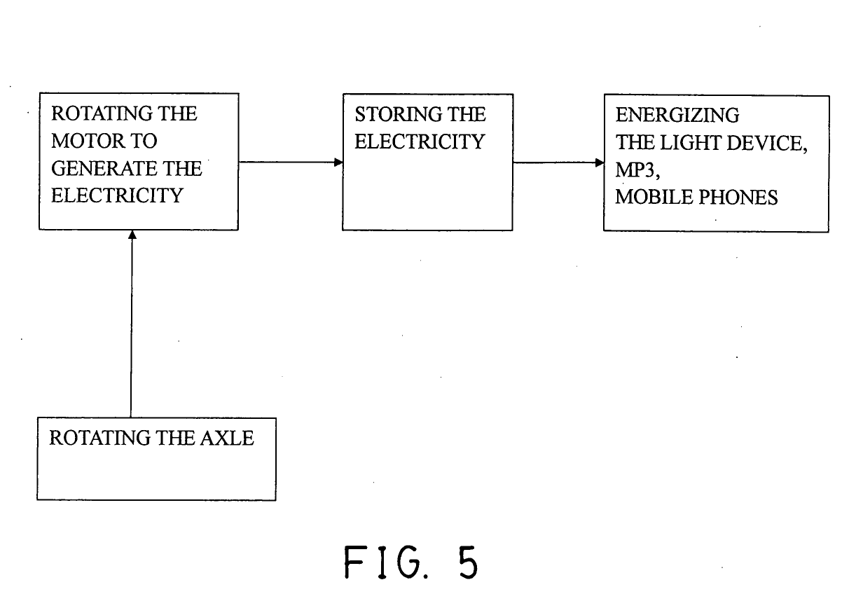

In operation, as shown in FIGS. 1, 2 and 5, the housing 10 may be easily and readily attached or secured to the bicycle frame 80, and may have the rotary member 20 frictionally engaged with the axle 85 for allowing the rotary member 20 and the reduction gearing 3 and the motor 40 to be rotated or driven by the axle 85 and to generate the electricity or electric energy when the axle 85 and the cranks 86 are stepped or driven by the user, and the electricity or electric energy generated by the motor 40 may then be supplied to energize the light device 53 or the other electric facilities, such as the mobile phones, the personal music players (MP3), the multimedia devices, or the like.

It is to be noted that the housing 10 may be easily and readily attached or secured to the bicycle frame 80, and the rotary member 20 may be easily and readily and frictionally engaged with the axle 85 without changing or modifying the structure of the bicycle 8. The typical generators for use on the bicycles failed to provided a rotary member 20 easily and readily attached or secured to the bicycle frame 80 and frictionally engaged with the axle 85, and failed to provided an electric generator for easily and readily attaching to various bicycles.

Accordingly, the electric generator in accordance with the present invention may be provided for easily and readily attaching to various bicycles and for generating an electricity or electric energy to energize the light devices, mobile phones, or other electric facilities.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An electric generator for a bicycle comprising:
a housing for attaching to a bicycle frame, and including a chamber formed therein,
a rotary member rotatably received in said chamber of said housing for engaging with an axle of the bicycle and for being rotated by the axle,
a reduction gearing received in said chamber of said housing and engaged with said rotary member,
a motor received in said chamber of said housing and including a pinion attached to a spindle of said motor and engaged with said reduction gearing for being driven by said reduction gearing and said rotary member and for generating an electric energy,
a battery electrically coupled to said motor for receiving and storing the electric energy generated by said motor, and
a light device electrically coupled to said battery for being energized by said battery.

2. The electric generator as claimed in claim 1 further comprising an electric coupler electrically coupled to said battery for electrically coupling to said light device.

3. The electric generator as claimed in claim 1 further comprising a circuit board received in said chamber of said housing and attached to said housing.

4. The electric generator as claimed in claim 1 further comprising an indicating light device electrically coupled to said battery for being energized by said battery to generate an indicating light.

5. The electric generator as claimed in claim 1 further comprising a switch electrically coupled to said battery for controlling the electric energy to said light device.

6. The electric generator as claimed in claim 1, wherein said housing includes a cover secured to said housing for closing said chamber of said housing and for retaining said rotary member and said reduction gearing and said motor in said housing.

7. The electric generator as claimed in claim 1, wherein said rotary member includes a primary gear attached thereto and rotated in concert with said rotary member, said reduction gearing includes a driven gear rotatably attached to said housing and meshed with said primary gear, an intermediate gear rotatably attached to said housing and having a pinion engaged with said driven gear, and a follower gear rotatably attached to said housing and having a pinion engaged with said intermediate gear, and said follower gear is engaged with said pinion of said motor.

8. The electric generator as claimed in claim 7, wherein said housing includes a plate secured to said housing for rotatably supporting said intermediate gear and said follower gear.

9. The electric generator as claimed in claim 1, wherein said housing includes an opening formed therein and communicating with said chamber of said housing for receiving the axle.

10. The electric generator as claimed in claim 1, wherein said housing includes a bracket secured to said housing and having an opening formed in said bracket for accommodating the axle.
